(19) United States
(12) Patent Application Publication
(10) Pub. No.: US 2026/0021733 A1
(43) Pub. Date: Jan. 22, 2026

(54) BIDIRECTIONAL ELECTRIC VEHICLE SUPPLY EQUIPMENT AND ENERGY MANAGEMENT SYSTEM

(71) Applicant: Enphase Energy, Inc., Petaluma, CA (US)

(72) Inventors: Shatruddha Singh KUSHWAHA, San Jose, CA (US); Martin DEGENER, Mountain View, CA (US); Mohammad ALKURAN, San Jose, CA (US); Vikas GAHLAN, Cupertino, CA (US)

(21) Appl. No.: 19/273,570

(22) Filed: Jul. 18, 2025

Related U.S. Application Data
(60) Provisional application No. 63/673,436, filed on Jul. 19, 2024.

(51) Int. Cl. B60L 53/51; B60L 53/63; B60L 53/64; B60L 53/67; B60L 55/00

(52) U.S. Cl. CPC B60L 53/51; B60L 53/63; B60L 53/64; B60L 53/67; B60L 55/00

(57) ABSTRACT

A bi-directional (BiDi) electric vehicle supply equipment (EVSE) configured as an energy management system or to connect to the energy management system is provided and comprises a first input/output configured to connect to at least one of a distributed energy resource (DER) power converter, a neutral forming transformer, or a load, a second input/output that is configured to connect to a main panel which is configured to connect to a home load and a meter of a grid, and a third input/output configured to connect to an electric vehicle (EV). The bi-directional (BiDi) electric vehicle supply equipment (EVSE) is configured to automatically transfer energy between each of the electric vehicle (EV), the distributed energy resource (DER) power converter, the grid, and the home load during operation.

### CROSS-REFERENCE TO RELATED APPLICATIONS

The present application claims the benefit of and priority to U.S. Provisional Application Ser. No. 63/673,436, filed on Jul. 19, 2024, the entire contents of which is incorporated herein by reference.

### BACKGROUND

### Field of the Disclosure

Embodiments of the present disclosure relate generally to methods and apparatus configured for use with/as electrical vehicle supply equipment (EVSE), and for example, to EVSE bi-directional (BiDi) charger.

### Description of the Related Art

EVs are mobile distributed energy resources, e.g., mobile storage. The EVs can be charged from an electrical grid, from private energy sources (e.g., photovoltaics (PV), and energy storage systems (stationary), or from a public energy source (e.g., Public EVSE). With unidirectional (one-way) EV chargers, electricity flows from an electric grid into the EV. Conversely, with bi-directional (BiDi), two-way EV chargers, electricity can flow both ways. For example, when an EV is charged, AC (alternating current) electricity from the electric grid is converted to DC (direct current) electricity, which can be used to charge the battery the EV. The conversion is conducted by either the EV's own converter or a converter located in the EVSE. Then, when a user wants to use the energy stored in the EV's battery, e.g., for providing electric power to house loads or feeding power back to the electric grid, the DC electricity stored in the EV is converted back to AC electricity. Common to BiDi EV charging are one or more power converters, which are configured to manage the electrical conversion, e.g., AC to DC and vice versa, and, in some instances, are configured to control an amount of power supplied to and from the EV battery. These power converters can be in the EV or in EVSE.

Thus, the inventors describe herein an improved EVSE bi-directional charger.

### SUMMARY

In accordance with aspects of the present disclosure there is provided an improved EVSE bi-directional (BiDi) chargers. For example, a bi-directional (BiDi) electric vehicle supply equipment (EVSE) configured as an energy management system or to connect to the energy management system comprises a first input/output configured to connect to at least one of a distributed energy resource (DER) power converter, a neutral forming transformer, or a load. A second input/output is configured to connect to a main panel which is configured to connect to a home load and a meter of a grid. A third input/output is configured to connect to an electric vehicle (EV). The bi-directional (BiDi) electric vehicle supply equipment (EVSE) is configured to automatically transfer energy between each of the electric vehicle (EV), the distributed energy resource (DER) power converter, the grid, and the home load during operation.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIG. 2 is a diagram of an EVSE system that is configured to connect to the energy management system of FIG. 1, in accordance with one or more embodiments of the present disclosure;

FIG. 3 is a diagram of bi-directional (BiDi) EVSE high level architecture, in accordance with one or more embodiments of the present disclosure;

FIG. 4 is a diagram of a multiple-EV energy management, in accordance with one or more embodiments of the present disclosure;

FIG. 5 is a diagram of operation of a multi-phase system, in accordance with one or more embodiments of the present disclosure; and

FIG. 6 is a diagram of operation of a split phase system, in accordance with one or more embodiments of the present disclosure.

### DETAILED DESCRIPTION

Embodiments of the present disclosure provide an improved EVSE bi-directional (BiDi) chargers. For example, a bi-directional (BiDi) electric vehicle supply equipment (EVSE) configured as an energy management system or to connect to the energy management system comprises a first input/output configured to connect to at least one of a distributed energy resource (DER) power converter, a neutral forming transformer, or a load. A second input/output is configured to connect to a main panel which is configured to connect to a home load and a meter of a grid. A third input/output is configured to connect to an electric vehicle (EV). The bi-directional (BiDi) electric vehicle supply equipment (EVSE) is configured to automatically transfer energy between each of the electric vehicle (EV), the distributed energy resource (DER) power converter, the grid, and the home load during operation to respectively achieve/perform at least one of PCS and MPU avoidance, grid tied operation, support for all generations of photovoltaic power converter, V2G, V2H and emergency backup, grid agnostic operation with grid sync, smart/dynamic charging, charging/discharging power limiting, high power charging through AC, green charging (charging only from excess solar), savings mode (charging from solar and lowest utility tariff period), or net zero (self-consumption). The methods and apparatus described herein allow a user to also make money via selling excess energy back to the grid, allow a user to save money by leveraging differential tariffs, and allow a user to be energy self-sufficient by connecting onsite renewables.

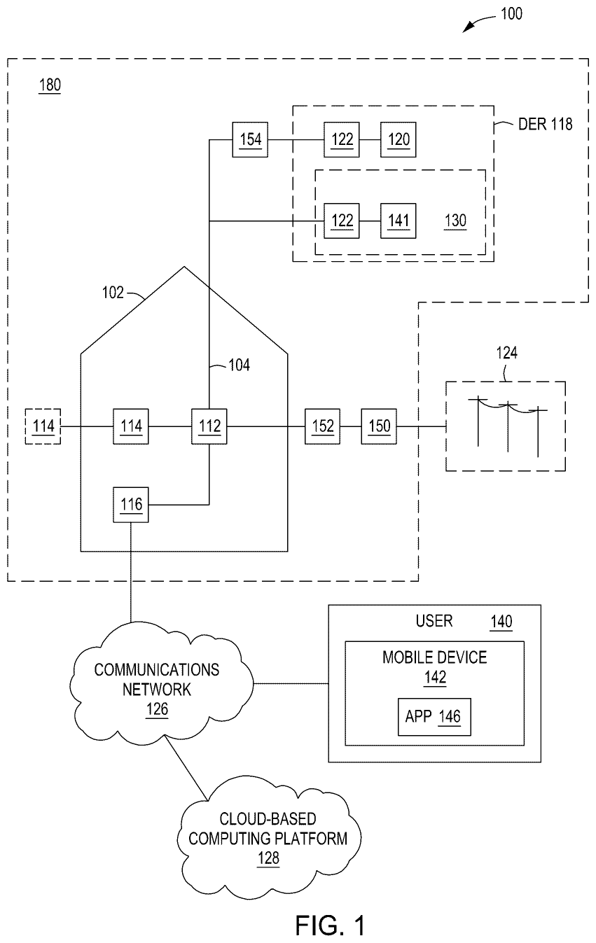

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 can be situated external or internal to the structure 102. For example, the DER 118 as solar power may be located on the roof of the structure 102 or can be part of a solar farm or DER 118 (such as a battery) can be situated inside the residential home. The structure 102 comprises one or more loads 114 (and/or energy storage devices), e.g., appliances, electric hot water heaters, thermostats/detectors, boilers, electric vehicle supply equipment (EVSE), water pumps, and the like, which can be located within or outside the structure 102, and a DER controller 116 (e.g., Enphase IQ Gateway), each coupled to a load center 112 (e.g., a main panel). Although the one or more loads 114 (and/or energy storage devices), the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the one or more loads 114 (and/or energy storage devices), DER controller 116, DER 118, load center 112, generation meter 154, the meter 152, and the MID 150 are part of a microgrid 180 (e.g., when the system 100 is not connected to the grid 124). It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one or many-to-one or one-to-many or any other configuration). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one (or two-to-one or many-to-one or one-to-many or any other configuration) correspondence, where each pair of power conditioner 122 and a corresponding battery may be referred to as an AC battery.

The power conditioners 122 invert the generated DC power from the plurality of RESs 120 and/or the battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the one or more loads 114 (and/or energy storage devices). In addition, the power conditioners 122 that are coupled to the batteries 141 convert AC power from the AC bus 104 to DC power for charging the batteries 141. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bi-directional inverter such as a simple charger onboard an EV. A key aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway or combiner or a Bidirectional (BiDi) EVSE (which includes a gateway and consolidates interconnection equipment into a single enclosure and streamlines PV and storage installations by providing a consistent, pre-wired solution for residential applications) that receives data (e.g., alarms, messages, operating data, performance data, and the like) from the power conditioners 122. The Bidirectional (BiDi) EVSE communicates the data and/or other information via the communications network 126 to a cloud-based computing platform 128 (e.g., Enphase Enlighten), which can be configured to execute one or more application software, e.g., a grid connectivity control application, to a mobile app, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method that provides the EVSE with a capability to directly (e.g., using current measurement inputs) or indirectly (e.g., using communication protocols to a remote measurement device) measure a net current being imported from or exported to a grid. Thereafter, the EVSE can use one or more control systems (e.g., an integral power control system (PCS)) to increase and/or decrease the charging and/or discharging rate of the EV to prevent overload of a service transformer, or grid interconnection, or any bus bar/feeder/breaker ratings, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (KW) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the AC battery 130 itself. The generation meter 154 can be connected internally or externally to the DER controller 116.

The meter 152 may be any suitable energy meter that measures the energy consumed/imported by the system 100, such as a net-metering meter, a bi-directional meter that measures energy imported from the grid 124 and as well as energy exported to the grid 124, a dual meter comprising two separate meters for measuring energy ingress and egress, and the like. In some embodiments, the meter 152 (which can also comprise a meter collar) comprises the MID 150 or a portion thereof. The meter 152 measures one or more of real power flow (KW), reactive power flow (kVAR), grid frequency, and grid voltage. The meter 152 measures power flows independently of MID state, i.e., when MID is closed and DER's are connected to the grid and when MID is open and DER's are isolated from the grid. The meter 152 can be internal or external to the DER controller 116.

The MID 150, which may also be referred to as an island interconnect device (IID), connects/disconnects the system 100 to/from the grid 124. That is, when the system 100 is disconnected from the grid 124, the system 100 becomes a microgrid. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122 and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124. The MID 150 can be internal or external to the DER controller 116.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, laptop or the like) communicably coupled by wireless/wired means to the communications network 126. The mobile device 142 has a CPU, support circuits, and memory, and has one or more applications (e.g., a grid connectivity control application (an application 146)) installed thereon for controlling the connectivity with the grid 124 as described herein. The may run on commercially available operating systems, such as IOS, ANDROID, WINDOWS and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, various scenarios/actions, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs, or generally parameterizes, the MID 150 to connect to or disconnect from the grid 124 as appropriate.

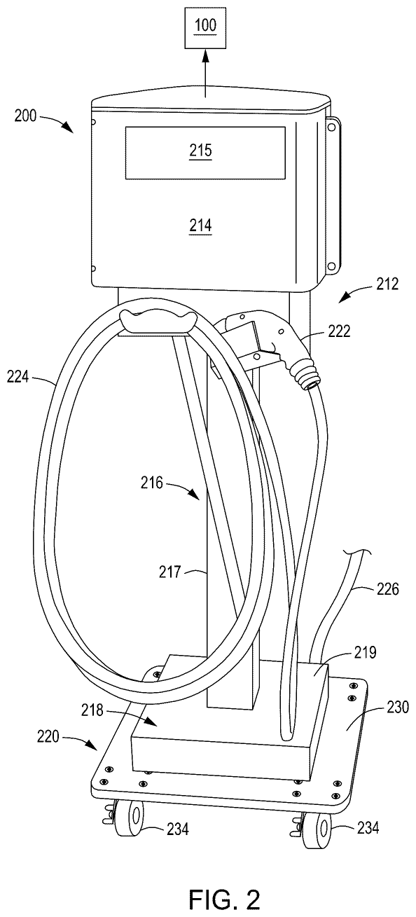

FIG. 2 is a diagram of an EVSE system (a system 200), in accordance with one or more embodiments of the present disclosure. As shown in FIG. 2, the system 200 is configured to connect to the system 100 and comprises electric vehicle supply equipment 212, a housing enclosure 214, a pedestal 216, a base 218, and a transport module 220 coupled to the base 218. The electric vehicle supply equipment 212 can include an electric vehicle connector 222, which can comprise a cord 224, configured for connection to an electric vehicle inlet (not shown). The electric vehicle supply equipment 212 can include a service entrance cable 226 configured to connect, for example, to the load center 112 wiring to deliver energy to the electric vehicle connector 222. The electric vehicle supply equipment 212 can include a controller 215 (e.g., similar to the DER controller 116) which can be housed in the housing enclosure 214. The electric vehicle supply equipment 212 can also include ungrounded, grounded, and equipment grounding conductors, attachment plugs, and other fittings, devices, power outlets, or apparatuses necessary to deliver energy from the premises wiring (not shown in FIG. 2) to an EV (not shown in FIG. 2), all or a portion of which may be enclosed within housing enclosure 214. The pedestal 216 is coupled to and supports the housing enclosure 214 and may include a hollow tubular portion 217 and a base 218. The base 218 may include a base cover 219 and a base plate (not shown) configured to engage and be supported on a top surface of the transport module 220. The transport module 220 comprises a platform 230 that is configured to support the base 218, and wheels 234 are provided on the platform 230 to facilitate moving the system 200 when not connected to the system 100. In addition, system 200 can have additional connection points to connect different DERs and Loads (similar to DER controller 116).

The electric vehicle supply equipment 212 (including electric vehicle connector 222, cord 224, and service entrance cable 226), the housing enclosure 214, and the pedestal 216 (including hollow tubular portion 217 and base 218), may be a commercially available electric vehicle charge station such as, for example but not limited to, a CS Series Public EVSE provided by ClipperCreek, Inc. of Auburn, Calif.

### Architecture

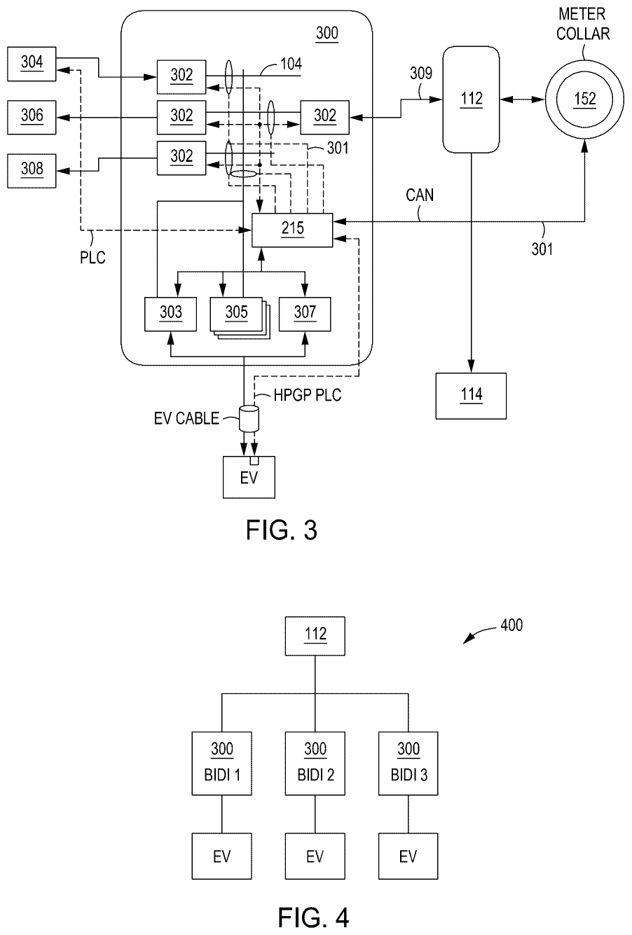

As described above, inventive concepts described herein provide improved Bidirectional (BiDi) EVSE. For example, FIG. 3 is a diagram of a BiDi EVSE 300 high level architecture configured to be used as the energy management system and the EVSE system of FIG. 1 and FIG. 2, in accordance with one or more embodiments of the present disclosure. For example, FIG. 3 illustrates one or more ways of integrating components of the BiDi EVSE 300 with components of an energy management system e.g., into a behind-the-meter solution amongst EV-ESS, PV, load control, and, in some instances, with PCS. In at least some embodiments, a BiDi-in-Aggregator (where BiDi+combiner functionalities are coupled into a single box) and BiDi charger (hereinafter BiDi) can be separate components. In at least some embodiments, a BiDi can be directly connected to a main panel (power and communication cables are connected between BiDi and main panel), as opposed to through an aggregator (if direct to meter integration is possible/desired). In at least some embodiments, a BiDi EVSE (BiDi charger, used interchangeably) can be a combination of an aggregator and charger.

The BiDi EVSE 300 may comprises one or more relays 302 (or other suitable disconnect device), bus bars (e.g., the AC bus 104, or any other way of electrical interconnection, such as a PCB), a feeder 309 (e.g., a set of conductors (wires) that carries electrical power from a source), a control area network 301 (CAN) or any other communication method, one or more controllers (e.g., the controller 215, a communications gateway (the DER controller 116, such as the Enphase IQ Gateway) which can act as a bridge between PVs (microinverters) and a monitoring system (Enphase Enlighten), ASIC etc.), an optional AC relay and safety board 303, one or more PCUs 305 (power conditioner units, e.g., BiDi power converters for DC EVSE), and a DC relay (or switching device) and safety board 307. The boards described herein can be disposed on one PCB or several PCBs. The BiDi EVSE 300 and components associated therewith connect to one or more DER micros (PV micros, battery micros, etc.), an optional neutral forming transformer 306 (NFT), optional loads 308, an EV (at a third input/output), a main panel (e.g., the load center 112) which connects to the home loads, and a meter (e.g., the meter 152). For example, the BiDi EVSE 300 connects at a first input/output to the one or more PV micros 304, an optional neutral forming transformer 306 (NFT), and/or optional loads 308 through the one or more relays 302 at a first input using at least one of a feeder, a wired connection, or a wireless connection. With modularity of relays, the BiDi EVSE 300 can be scaled over a period of time, and one or more additional PVs, NFT, loads, batteries, etc. can be added on demand. Alternatively, or additionally, one or more sub panels with additional relays can be added to extend the control circuit of BiDi EVSE 300. Additionally, all power flows through the BiDi EVSE 300 bus bar and all connection points on the bus bar can be metered and current controlled, which provides optimized PV generation, power for storage in the battery, charging/discharging the EV and other optional loads under different use-cases.

The BiDi EVSE 300 can be a standalone charger and can be integrated with one or more PVs (e.g., PV control) and/or power control systems (PCS). The BiDi EVSE 300 can be configured to redirect energy between different DERs, operate within busbar limits, and can provide additional charge power from the PV micros (e.g., solar) when operating at maximum grid pull. In at least some embodiments, the BiDi EVSE 300 can be configured to operate as a partial backup with islanding. In at least some embodiments, the BiDi EVSE 300 is configured to provide emergency power backup to the connected loads without any external components, as described in greater detail below.

The BiDi EVSE 300 can be configured for AC and/or DC operation based on presence of the AC relay and safety board 303, the PCUs 305, and the DC relay and safety board 307 (e.g., a second input/output). For example, the AC relay and safety board 303 can be used for AC operation, the PCUs 305 and the DC relay and safety board 307 can be used for DC operation, and the AC relay and safety board 303, the PCUs 305, and the DC relay and safety board 307 can be used in conjunction for both AC and DC operation. In at least some embodiments, the BiDi EVSE 300 can charge simultaneously on both AC and DC.

As noted above, the BiDi EVSE 300 bus bar connection architecture and all sub-components (primary or optional e.g., the AC relay and safety board 303, the PCUs 305 and the DC relay and safety board 307) connect to this bus bar, and such modular architecture allows scalability and extendibility. For example, for 11 kW DC EVSE, if there are six (6) PCUs, one of the PCUs can be replaced with an AC Relay and safety board and the BiDi EVSE 300 becomes operable in both AC and DC modes (e.g., a multi-mode BiDi).

In at least some embodiments, the BiDi EVSE 300 can have multiple AC relay and safety boards connected to the bus bar and can have multiple EV cables to create a multi-port BiDi EVSE. In such embodiments, the BiDi EVSE 300 can be configured to intelligently power limit to achieve maximum power draw from the grid. Additionally, in such embodiments, the BiDi EVSE 300 can be configured to charge one EV from another EV based on, for example, benefit selection by a user (e.g., a user participates in a program where a user that is discharging receives a lower tariff and a user that is charging or requires a faster charge pays higher tariff).

In at least some embodiments, the BiDi EVSE 300 can be configured to automatically draw more power from connected PVs to charge an EV at higher power than provided by a grid connection.

In at least some embodiments, the BiDi EVSE 300 can be combined with a meter collar (part of the meter 152), and when combined, the BiDi EVSE 300 can dynamically manage the charging/discharging/pause power based on the one or more loads 114 (e.g., changing loads) and stay within grid connection limits, e.g., more power if solar is available and distributing the power adhering to bus bar current limitations on main panel and the BiDi EVSE 300.

In at least some embodiments, the BiDi EVSE 300 can comprise an intelligence unit (CCU, e.g., the controller 215) that is configured to control and communicate secondary controls to the PCUs (PV, battery, BiDi, etc.) and can have PCS and EV communication (e.g., using PLC and/or HomePlug Green PHY (HPGP) PLC).

In at least some embodiments, the BiDi EVSE 300 bus bars (or wires or PCB) can comprise one or more integrated current sensors, e.g., directly on the busbar, with no external wire routing needed. In at least some embodiments, the BiDi EVSE 300 can have net zero metering, which can lower electricity costs.

In at least some embodiments, the BiDi EVSE 300—when integrated with a home energy management system which may comprise a battery storage system, PV, and controllers—can be configured for green charging using only excess PV energy, e.g., intelligent green charging. In such embodiments, the BiDi EVSE 300 can be configured to charge a battery when an EV is not present, transfer green electrons from a battery to EV when EV is connected, and empty the battery for next day's solar storage.

### Multi-EV Energy Management

FIG. 4 is a diagram of a multiple-EV energy management system 400, in accordance with one or more embodiments of the present disclosure. In such an embodiment, the BiDi EVSE 300 (e.g., BiDi₁, BiDi₂, . . . . BiDiₙ) is configured to couple to a corresponding electric vehicles (EV) (e.g., three (3) EVs shown in a common EV lot) and is configured to coordinate charging behind a main panel (e.g., the load center 112). In at least some embodiments, the BiDi EVSE 300 is configured to prioritize one EV over the another EV based on one or more of departure times, customer ranking (premium customer), etc. Additionally, the BiDi EVSE 300 is configured to boost charging power, for example, by drawing power from one EV to another EV, thus avoiding a need for increased import from the grid. In addition, the BiDi EVSE 300 is configured to charge the EVs at higher power when grid tariff is low. In addition, the BiDi EVSE 300 is configured to credit users for/with free parking for discharge availability (GS) or actual discharge, and other behind-the-meter use cases. In addition, the BiDi EVSE 300 is configured to prioritize an EV for a grid service event in case of multiple BIDI systems (e.g., prioritizing one electric vehicle (EV) over another electric vehicle (EV)). The prioritization can be based on available energy, departure time, temperature, learnings data, or other suitable parameters.

In at least some embodiments (e.g., in commercial spaces), the BiDi EVSE 300 can connect to one or more EVs (e.g., employee EVs) connected to support the utility grid (e.g., for peak shaving), and provide different services (e.g., but not limited to free charging) in return.

In at least some embodiments, the BiDi EVSE 300 can be configured to provide storage as a service, such as when an EV is connected to the BiDi EVSE 300. For example, the BiDi EVSE 300 can be configured to store energy in the EV and can be configured to export energy back from the EV. In such embodiments, the BiDi EVSE 300 is in operative communication with the cloud-based computing platform 128 and together therewith is configured to ensure that energy stored and exported sums up to zero, and the EV user can be paid for the amount of energy that was stored in the EV user's EV for short duration. Additionally, in such embodiments, the energy storage and export can be spread over multiple sessions. For example, in a scenario when an EV comes with 50 kWh of energy, the BiDi EVSE 300 can store 10 kWh of energy and export 5 kWh. When, the EV leaves and comes back sometime thereafter, for example, a week, the BiDi EVSE 300 can store 5 kWh of energy and export 10 kWh. The BiDi EVSE 300 together with Cloud-Based Computing Platform 128 can store a record associated with each EV and an energy ledger. An EV can connect to any of the BiDi EVSE 300 (e.g., BiDi₁, BiDi₂, . . . . BiDiₙ) and participate in storage as a service. Moreover, an EV user can take credit from the EV user's stored energy for the EV user's personal use and can be billed for usage of the energy. When connecting to the BiDi EVSE 300, an EV user can also select x amount of kWh, and the BiDi EVSE 300 can charge the EV user to y amount (e.g., y>x), and can bill the EV user for x amount and add y-x to the EV user's energy ledger.

In at least some embodiments, at a time of a grid service event, an EV user can be notified with the EV user's nearest empty BiDi EVSE, e.g., a nearest location of an unoccupied BiDi EVSE. Such a notification can be provided to the EV user prior to the grid service event or during the grid service event. Additional service can be provided to the user to block an unoccupied BiDi EVSE.

In at least some embodiments, an EV user can choose to export more energy from an EV than available in the EV user's ledger and earn more, and extra energy can be paid to the EV user as future energy storage credits or pure energy cost or any other service/credits.

### Series/Parallel Switching

In at least some embodiments, the BiDi EVSE 300 can use one or more series/parallel power converters, controllable by switch arrangement (e.g., centralized switching or distributed), to achieve optimum I-V range (e.g., 400 V/800 V). In such embodiments, each power converter can comprise of 2 or more parallel DC outputs. Based on a type of vehicle (e.g., 400 V or 800 V), the power converter's DC output is connected in parallel (for 400 V) or series (for 800 V). The DC output can be optimized for the best performance in a selected voltage range (e.g., 350 V to 400 V, 3 A). Thus, when in parallel, an overall best performance in that selected range can be achieved. Similarly, when in series, an overall best performance in two sets of voltage ranges can be achieved. In some embodiments, when the BiDi EVSE 300 operates in a full voltage range, an overall best performance can be in one range. In at least some embodiments, switching interlocks are provided for safety, thus ensuring that all power converters are simultaneously connected as either parallel or series. In at least some embodiments, one or more switching relays/contactors can be provided on the plug of an EV cable of the BiDi EVSE 300. In doing so, the BiDi EVSE 300 is uniquely suitable for 800 V EV charging while staying compliant to safety standards which require/state that only up to 600 V DC can be present between two conductors in a dwelling.

### Multi-Phase System

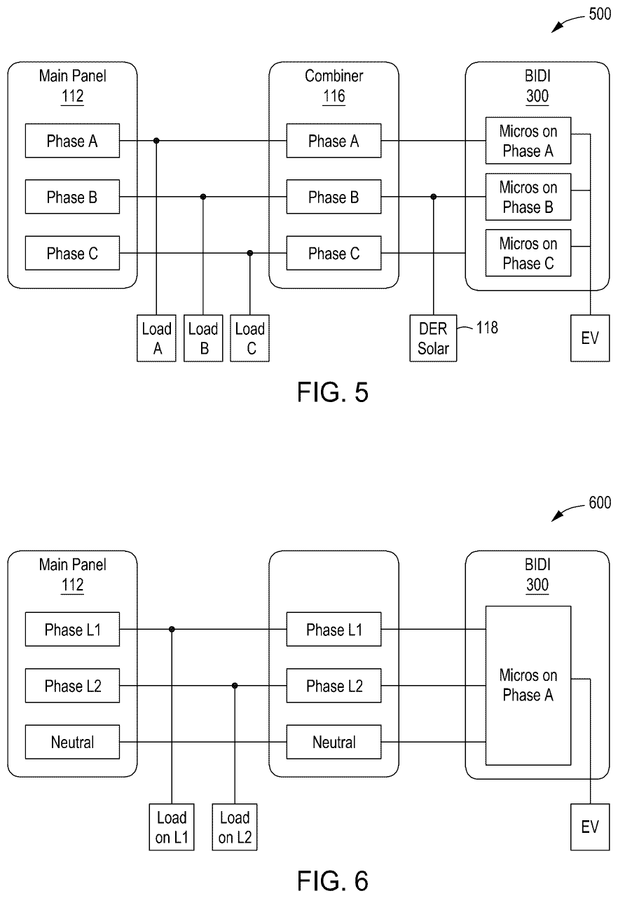

FIG. 5 is a diagram of operation of a one of the possible configuration of BiDi EVSE 300 as a multi-phase system 500, in accordance with one or more embodiments of the present disclosure. For example, when charging, the BiDi EVSE 300 can be configured to dynamically pull different current from different phases to keep a balanced power withdraw from the grid (e.g., when there are other home loads operating in the home on some of the phases), thus ensuring at home level, balanced power withdraw from the grid (e.g., based on bus bar limitations of the main panel and the grid). In such embodiments, the BiDi EVSE 300 is configured to take into account (based on) bus bar limitations of the main panel (the load center 112) and grid connection. For example, if there is a three (3) phase connection with 32 A on each phase, 24 A home loads are connected on phase A, 16 A on phase B, no load on phase C, the BiDi EVSE 300 is can dynamically draw 8 A on Phase A, 16 A on phase B, 32 A on phase C to maximize a charging power, while balancing the grid import and ensuring to operate within the bus bar limits.

The BiDi EVSE 300 can be configured to use excess solar power (e.g., connected on a few phases only) for boost charging, while maintaining the bus bar limitations. For example, in the previous example, if a 16 A solar panel is connected on a combiner box (e.g., the DER controller 116,) on phase B and the BiDi EVSE 300 is also connected on the combiner, while home loads are connected to main panel, the BiDi EVSE 300 can dynamically draw 8 A on Phase A, 32 A on Phase B (e.g., 16 from main panel and 16 from solar), and 32 A from phase C to maximize charging.

In at least some embodiments, for green charging, the BiDi EVSE 300 is configured to pull excess PV current individually from each phase to charge an EV. Additionally, in at least some embodiments, for net zero, the BiDi EVSE 300 is configured to pull excess PV from one or more phases, while providing power to other phases.

In at least some embodiments, the BiDi EVSE 300 is configured to charge on one phase, while discharging on another phase. For example, when there is excess solar available on phase B, and phase A has home loads connected and needs emergency backup.

In at least some embodiments, the BiDi EVSE 300 is configured to transfer power from one phase to another phase, even when an EV is not connected, e.g., when there is solar on one phase and loads on another phase, or excess solar on one phase that can be utilized on another phase.

### Split Phase System—Balancing of Power

FIG. 6 is a diagram one of the possible modes of operation of BiDi EVSE 300 in one of the split phase system 600, in accordance with one or more embodiments of the present disclosure. For example, the BiDi EVSE 300 is configured to draw different power from different phases, even in the case of split phase to ensure maximum use of available power. For example, if a main panel is rated for 100 A, a 100 A of current can be on phase L1 and 100 A of current can be on phase L2. Most high power equipment in a home can be connected across phase L1 and phase L2 and operate at 240 V. Significant loading, however, on the split phase (e.g., phase L1 and phase L2) can be present. In conventional power control systems, if any of the phase current reaches the limit (e.g., 100 A), the conventional power system is configured to limit the power. Conversely, in a situation where 100 A is being drawn on phase L1 and 70 A is being drawn on phase L2, the BiDi EVSE 300 is configured to dynamically use the rest of the available power (e.g., 100 A−70 A=30 A available only L2, no power on L1). In at least some embodiments, the number of PCS and MPU can be added as needed to facilitate balancing of power.

### Software

The BiDi EVSE 300 can have instructions stored thereon that when executed by a processor is configured to perform a method for performing one or more of the operations described herein. For example, the BiDi EVSE 300 is configured to perform a method for intelligent management of energy. In at least some embodiments, the BiDi EVSE 300 is configured to perform the method for intelligent management of energy based on, for example, a weather forecast, an EV usage pattern, a user choice of operating mode, and/or a home's expected energy needs.

In at least some embodiments, the BiDi EVSE 300 is configured to perform a method for intelligent hybrid charging using a combination of an EV's onboard charger (OBC), e.g., AC charging, for faster charging, and DC bidirectional charger (e.g., capable of V2G and V2H, emergency backup). For example, based on a configuration and available time to charge, the BiDi EVSE 300 is configured to select an AC or DC mode of charging. For example, in one scenario, an EV comes in at 10:00 PM with 20% state-of-charge (SoC) and needs to go out at 6:00 AM with 80+% SoC, but there is a predicted/unknown power outage between 2:00 AM to 3:00 AM, low tariff between 11:00 PM-1:00 PM, and a grid service event between 3:00-4:00 AM. In at least some embodiments, in such a scenario, the BiDi EVSE 300 is configured to 1) charge the EV with faster charging (by using OBC and DC charging together or if OBC is capable of more power than DC charging) from 10:00 till 1:30, 2) switch to DC bidirectional charging at 1:30, 3) provide uninterrupted power backup if power is interrupted, 4) export power back to the grid from 3:00 to 4:00 AM to generate money, and 5) switch back to fast charging to complete the charging by 6:00 AM.

In another scenario, an EV OBC is at 22 kW and the EV needs 110 kWh of energy charged from 10:00 PM till 6:00 AM. For example, at 11 kW (e.g., if DC charging is rated at 11 kw), typically, such an event takes about 10 hours, but there is only eight (8) hours available. In at least some embodiments, in such a scenario, the BiDi EVSE 300 is configured to 1) charge the EV with AC OBC for about 2 hours (or more depending tariff period), 2) charge the EV with DC charging for 6 hours, 3) intelligently decide when to restart the 2 hours of AC OBC (e.g., based on a lowest tariff), and 4) stay in a DC charging mode based on predictions for grid services and/or power outage events.

The BiDi EVSE 300 is configured to perform a method for intelligent management of energy based on daily behavior, home energy consumption, machine learning and artificial intelligence logics. For example, the BiDi EVSE 300 is configured to predict a power consumption to ensure that a home operates within a maximum current limit from a grid. For example, a home can have about 100 A grid connection with a 100 A main panel. Based on this information and predictions, the BiDi EVSE 300 can be configured to determine/know a home's loads requirements (e.g., 80 A of current from 12:00 to 2:00, which would leave no power left for charging the EV during that period) and retain and consider such information to make an intelligent decision while charging. In at least some embodiments, in such a scenario, the BiDi EVSE 300 is configured to 1) dynamically adjust the EV charging power, e.g., EV is charging at about 40 A and there is about 40 A home load, 2) if the home's loads increase to about 60 A, reduce the EV charging to about 20 A, and 3) if the home's loads reduce to 20 A, increase the EV charging to about 60 A.

The BiDi EVSE 300 is configured to perform a method for intelligent transfer of energy to/from a fixed battery, an EV, and/or EV-EV based on predictions that can comprise one or more of next day usage, next day sun, next day power outage, and next day travel or any of the other conditions or logics mentioned in this document.

For example, when the BiDi EVSE 300 is rightly/correctly sized for PV and stationary storage, the system 100 is configured to store solar energy in a stationary battery (e.g., the AC battery 130) during the day, store renewable wind energy in the night, and transfer the green electrons into the EV for the next day's EV run, while also emptying the fixed battery so that the fixed battery can be charged for the next day's solar. In such an embodiment, enough stored energy is kept available in the fixed battery for the next day's predictions of power outage and grid service events.

In at least some embodiments, such as when there are multiple BiDi EVSE 300 at a location or there are the BiDi EVSE 300 and a smart unidirectional EVSE, the BiDi EVSE 300 is configured to charge one EV from another EV. Such an embodiment is advantageous when there is no grid and an EV user wants one of the EVs charged. Such an embodiment is also advantageous when operating under load conditions where most of the grid and PV power are consumed by the home's loads but the EV also needs to be charged. In such an instance, the BiDi EVSE 300 is configured to provide additional power from another EV and transfer the power while maintaining the main panel (e.g., the load center 112) bus bar limitations.

In at least some embodiments, the BiDi EVSE 300 is configured as an enhanced storm guard. For example, during a power outage caused by a storm and when a battery (e.g., the AC battery 130) SoC is low, the BiDi EVSE 300 is configured to transfer energy from the EV to charge the battery to acceptable SoC levels. Alternatively or additionally, in such a scenario, when there is an extended grid outage, the EV can be charged at another location (e.g., another home, public power lot, etc.) and return home and used to charge the battery as previously described.

### Multiple Inverter Power Optimization

In at least some embodiments, the BiDi EVSE 300 is configured to operate power converters at the power converter's optimal power point by turning off other power converters. For example, in a charging scenario, when the BiDi EVSE 300 has, for example, six (6) power converters (e.g. each having available charging power of about 2 kW with an efficiency of 97% at full power, which reduces gradually with lower power). If an EV is to be charged at 3 kW and if all six (6) power converters are being used, each power converter can provide about 500 W of power (e.g., about 33% of rated power) and will operate at lower efficiency e.g., about 90%. In at least some embodiments, in such a scenario, the BiDi EVSE 300 is configured to run a first power converter at full power (e.g., about 100% of rated power=about 2 kW with 97% efficiency) and a second power converter at less than full power (e.g., about 50% of rated power=about 1 kW with 93% efficiency), which will achieve an overall higher efficiency of charging (˜95% for this example). The BiDi EVSE 300 can be configured to perform the same or similar operation in a discharging scenario (e.g., when there is lower power to be discharged) to reduce number of operating power converters to maximize the power converter efficiency.

In at least some embodiments, the BiDi EVSE 300 can be configured to detect seismic/collision/damaging events and turn off charging.

In at least some embodiments, the BiDi EVSE 300 can comprise one or more add-on accessories. For example, the one or more add-on accessories can be configured to connect two or more of the BiDi EVSE 300 (e.g., two BiDi EVSE each rated at 11 kW). For example, in at least some embodiments, two or more of the BiDi EVSE 300 can be connected to each other via the two or more of the BiDi EVSE 300 DC buses, e.g., via contactors. In such embodiments, both of the BiDi EVSE 300 can have individual cables connected to corresponding two EVs so both of the BiDi EVSE 300 operate as separate 11 kW units. Alternatively, when only one of the BiDi EVSE 300 is connected to an EV, the BiDi EVSE 300 can charge at 22 kW. Such embodiments, provide higher modularity, less development, and a user can upgrade from 11 kW to 22 kW if desired and can charge two EVs at 11 kW or one EV at 22 kW. In at least some embodiments, the multiple chargers (e.g., multiple BiDi EVSE) can be connected to provide higher power at the EV Plug. e.g., a charger A and a charger B can each be rated for x kW power. When EVs C and D are connected to the charger A and the charger B, respectively, the EV C can be charged at 2*x power or the EV D can be charged at 2*x power or the EV C and the EV D can individually be charged at x power simultaneously. In such embodiments, the combined intelligence of both the charger A and the charger B, along with HEMS and EV, can be configured to prioritize a charging rate automatically or a user can selectively configure the charger A and the charger B to charge one EV at a higher rate through, for example, a smartphone.

While the foregoing is directed to embodiments of the present disclosure, other and further embodiments of the disclosure may be devised without departing from the basic scope thereof, and the scope thereof is determined by the claims that follow.

What is claimed is:

1. A bi-directional (BiDi) electric vehicle supply equipment (EVSE) configured as an energy management system or to connect to the energy management system, comprising:
a first input/output configured to connect to at least one of a distributed energy resource (DER) power converter, a neutral forming transformer, or a load;
a second input/output that is configured to connect to a main panel which is configured to connect to a home load and a meter of a grid; and
a third input/output configured to connect to an electric vehicle (EV),
wherein the bi-directional (BiDi) electric vehicle supply equipment (EVSE) is configured to automatically transfer energy between each of the electric vehicle (EV), the distributed energy resource (DER) power converter, the grid, and the home load during operation.

2. The bi-directional (BiDi) electric vehicle supply equipment (EVSE) of claim 1, wherein the bi-directional (BiDi) electric vehicle supply equipment (EVSE) is further configured to automatically draw power from connected PVs to charge the electric vehicle (EV) at higher power than provided by the grid.

3. The bi-directional (BiDi) electric vehicle supply equipment (EVSE) of claim 1, wherein the bi-directional (BiDi) electric vehicle supply equipment (EVSE) is further configured to dynamically manage charging/discharging/pausing of power based on the home load to stay within connection limits of the grid.

4. The bi-directional (BiDi) electric vehicle supply equipment (EVSE) of claim 1, wherein the bi-directional (BiDi) electric vehicle supply equipment (EVSE) is further configured to charge simultaneously on both AC and DC.

5. The bi-directional (BiDi) electric vehicle supply equipment (EVSE) of claim 1, wherein the bi-directional (BiDi) electric vehicle supply equipment (EVSE) is further configured to use only excess PV energy to charge a battery of the energy management system when the electric vehicle (EV) is not present, transfer electrical from the battery to the electric vehicle (EV) when the electric vehicle (EV) is connected, and empty the battery for a next day's solar storage.

6. The bi-directional (BiDi) electric vehicle supply equipment (EVSE) of claim 1, wherein the bi-directional (BiDi) electric vehicle supply equipment (EVSE) is further configured to communicate with other the bi-directional (BiDi) electric vehicle supply equipment (EVSE).

7. The bi-directional (BiDi) electric vehicle supply equipment (EVSE) of claim 6, wherein the bi-directional (BiDi) electric vehicle supply equipment (EVSE) and other bi-directional (BiDi) electric vehicle supply equipment (EVSE) are configured to connect to corresponding electric vehicle (EVs) and are configured to coordinate charging of the corresponding electric vehicle (EVs) with other distributed energy resources and loads behind the main panel.

8. The bi-directional (BiDi) electric vehicle supply equipment (EVSE) of claim 7, wherein to coordinate charging of the EVs behind the main panel comprises prioritizing one electric vehicle (EV) over another electric vehicle (EV) for a grid service event based on at least one of available energy, departure time of the EVs, temperature, learnings data, or customer ranking.

9. The bi-directional (BiDi) electric vehicle supply equipment (EVSE) of claim 8, wherein the bi-directional (BiDi) electric vehicle supply equipment (EVSE) and the other the bi-directional (BiDi) electric vehicle supply equipment (EVSE) are configured to boost charging power by drawing power from one EV to another EV to avoid a need for increased import from the grid.

10. The bi-directional (BiDi) electric vehicle supply equipment (EVSE) of claim 1, wherein the bi-directional (BiDi) electric vehicle supply equipment (EVSE) is further configured to charge the electric vehicle (EV) at higher power when a grid tariff is low.

11. The bi-directional (BiDi) electric vehicle supply equipment (EVSE) of claim 1, wherein the bi-directional (BiDi) electric vehicle supply equipment (EVSE) is further configured to credit users for at least one of discharge availability for grid services, actual discharge, or other behind-the-meter use cases.

12. The bi-directional (BiDi) electric vehicle supply equipment (EVSE) of claim 1, wherein the bi-directional (BiDi) electric vehicle supply equipment (EVSE) is further configured to provide storage as a service when connected to the electric vehicle (EV).

13. The bi-directional (BiDi) electric vehicle supply equipment (EVSE) of claim 12, wherein the bi-directional (BiDi) electric vehicle supply equipment (EVSE) is further configured to store energy in the EV and export energy back to the grid from the electric vehicle (EV).

14. The bi-directional (BiDi) electric vehicle supply equipment (EVSE) of claim 13, wherein the bi-directional (BiDi) electric vehicle supply equipment (EVSE) is in operative communication with a cloud-based computing platform and is further configured to ensure that energy stored in and exported from the electric vehicle (EV) sums up so that the electric vehicle (EV) user can be paid for stored energy in the electric vehicle (EV).

15. The bi-directional (BiDi) electric vehicle supply equipment (EVSE) of claim 1, wherein the first input/output is configured to connect to the at least one of the distributed energy resource (DER) power converter, the neutral forming transformer, or the load via at least one of a feeder or wired connection.

16. The bi-directional (BiDi) electric vehicle supply equipment (EVSE) of claim 1, wherein the bi-directional (BiDi) electric vehicle supply equipment (EVSE) is further configured to control and communicate secondary controls to the distributed energy resource (DER) power converter and the electric vehicle (EV) using at least one of PLC or HomePlug Green PHY (HPGP) PLC.

17. The bi-directional (BiDi) electric vehicle supply equipment (EVSE) of claim 1, wherein the distributed energy resource (DER) power converter is a component of at least one of a photovoltaic module or a battery.

18. The bi-directional (BiDi) electric vehicle supply equipment (EVSE) of claim 1, wherein the bi-directional (BiDi) electric vehicle supply equipment (EVSE) is further configured to dynamically pull different current from different phases to keep a balanced power withdraw from the grid based on bus bar limitations of the main panel and the grid.

19. The bi-directional (BiDi) electric vehicle supply equipment (EVSE) of claim 1, wherein the bi-directional (BiDi) electric vehicle supply equipment (EVSE) is further configured to use excess solar power for boost charging, while maintaining bus bar limitations.

20. The bi-directional (BiDi) electric vehicle supply equipment (EVSE) of claim 1, wherein the bi-directional (BiDi) electric vehicle supply equipment (EVSE) is further configured to pull excess PV current individually from each phase to charge the electric vehicle (EV).
